(19) United States
(12) Patent Application Publication
(10) Pub. No.: US 2020/0034941 A1
(43) Pub. Date: Jan. 30, 2020

(54) INFORMATION PROCESSING APPARATUS, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventors: Akihiko NAKANISHI, Nisshin-shi (JP); Daigo FUJII, Tsushima-shi (JP); Makoto TANAKA, Toyota-shi (JP); Kazuki TAKEUCHI, Toyota-shi (JP); Chie KOIKE, Nagoya-shi (JP); Daiki KANEICHI, Nisshin-shi (JP); Tsuyoshi OKADA, Toyota-shi (JP)

(73) Assignee: TOYOTA JIDOSHA KABUSHIKI KAISHA, Toyota-shi (JP)

(21) Appl. No.: 16/508,353

(22) Filed: Jul. 11, 2019

(30) Foreign Application Priority Data
Jul. 25, 2018 (JP) 2018-139333

(51) Int. Cl. G06Q 50/30; G06F 16/29; G01C 21/34

(52) U.S. Cl. CPC G06Q 50/30; G01C 21/3438; G06F 16/29

(57) ABSTRACT

An information processing apparatus according to the present disclosure is provided with a controller configured to execute: acquiring places of departure and destinations of fellow passenger users; determining as getting-in spots, spots which are different from the places of departure in a first range including the places of departure of the fellow passenger users and at which a third party can recognize a situation in which the fellow passenger users get in the vehicle; determining as getting-off spots, spots which are different from the destinations in a second range including the destinations of the fellow passenger users and at which a third party can recognize a situation in which the fellow passenger users get off the vehicle; and transmitting the getting-in spots and the getting-off spots of the fellow passenger users to an apparatus related to the vehicle.

### CROSS-REFERENCE TO RELATED APPLICATIONS

This application claims the benefit of Japanese Patent Application No. 2018-139333, filed on Jul. 25, 2018, which is hereby incorporated by reference herein in its entirety.

### BACKGROUND

### Technical Field

The present disclosure relates to an information processing apparatus, an information processing method and a non-transitory storage medium.

### Description of the Related Art

Techniques for determining whether or not owners of terminals are sharing the same vehicle based on position information of the respective terminals and calculating environment loads such as CO₂ emission and fuel consumption based on the determination result are known (e.g., see Patent Literature 1)

### CITATION LIST

### Patent Literature

Patent Literature 1: Japanese Patent Application Laid-Open No. 2011-237842

### SUMMARY

It is an object of the present disclosure to provide a technique capable of suitably preventing users from losing privacy in ride sharing in which a plurality of users share the same vehicle for traveling.

In a mode in which a plurality of users share the same vehicle, an information processing apparatus according to the present disclosure is an information processing apparatus that sets getting-in spots and getting-off spots of fellow passenger users who ride in the vehicle as non-drivers. The information processing apparatus is provided with a controller including at least one processor. The controller is configured to execute: acquiring places of departure and destinations of the fellow passenger users; determining as getting-in spots, spots which are different from the places of departure in a first range including the places of departure of the fellow passenger users and at which a third party can recognize a situation in which the fellow passenger users get in the vehicle; determining as getting-off spots, spots which are different from the destinations in a second range including the destinations of the fellow passenger users and at which a third party can recognize a situation in which the fellow passenger users get off the vehicle; and transmitting the getting-in spots and the getting-off spots of the fellow passenger users to an apparatus related to the vehicle.

Furthermore, in a mode in which a plurality of users share the same vehicle, the present disclosure can also be considered as an information processing method of setting getting-in spots and getting-off spots of fellow passenger users who ride in the vehicle as non-drivers. In that case, the information processing method according to the present disclosure may be configured to cause a computer to execute: a step of acquiring places of departure and destinations of the fellow passenger users; a step of determining as getting-in spots, spots which are different from the places of departure in a first range including the places of departure of the fellow passenger users and at which a third party can recognize a situation in which the fellow passenger users get in the vehicle; a step of determining as getting-off spots, spots which are different from the destinations in a second range including the destinations of the fellow passenger users and at which a third party can recognize a situation in which the fellow passenger users get off the vehicle; and a step of transmitting the getting-in spots and the getting-off spots of the fellow passenger users to an apparatus related to the vehicle.

Furthermore, in a mode in which a plurality of users share the same vehicle, the present disclosure can also be considered as an information processing program or a non-transitory storage medium that stores the information processing program for setting getting-in spots and getting-off spots of the fellow passenger users who ride in the vehicle as non-drivers. The information processing program in that case may be configured to cause a computer to execute: a step of acquiring places of departure and destinations of the fellow passenger users; a step of determining as getting-in spots, spots which are different from the places of departure in a first range including the places of departure of the fellow passenger users and at which a third party can recognize a situation in which the fellow passenger users get in the vehicle; a step of determining as getting-off spots, spots which are different from the destinations in a second range including the destinations of the fellow passenger users and at which a third party can recognize a situation in which the fellow passenger users get off the vehicle; and a step of transmitting the getting-in spots and the getting-off spots of the fellow passenger users to an apparatus related to the vehicle.

According to the present disclosure, in ride sharing in which a plurality of users share the same vehicle for traveling, it is possible to suitably prevent the users from losing privacy.

### BRIEF DESCRIPTION OF THE DRAWINGS

FIG. 1 is a diagram for describing an overview of ride-sharing;

FIG. 2 is a diagram illustrating a schematic configuration of a ride-sharing system;

FIG. 3 is a diagram illustrating a hardware configuration of a user terminal and a server apparatus;

FIG. 4 is a block diagram illustrating a functional configuration of the server apparatus;

FIG. 5 is a diagram illustrating a configuration example of a traveling schedule information table;

FIG. 6 is a diagram illustrating a configuration example of a movement schedule information table;

FIG. 7 is a diagram illustrating a configuration example of a reservation information table;

FIG. 8 is a diagram illustrating another configuration example of the reservation information table;

FIG. 9 is a diagram illustrating a configuration example of a member information table;

FIG. 10 is a diagram for describing a method of setting getting-in spots of fellow passenger users;

FIG. 11 is a flowchart illustrating an overview of a flow of data transmitted/received among respective components of a ride sharing system and a flow of processes carried out by the respective components; and

FIG. 12 is a flowchart illustrating operation of a server apparatus when executing a privacy process.

### DESCRIPTION OF EMBODIMENTS

In a mode in which a plurality of users share the same vehicle (ride sharing), the present disclosure is an information processing apparatus for setting getting-in spots and getting-off spots of the users who ride in the vehicle as non-drivers (fellow passenger users).

Here, when getting-in spots and getting-off spots of the fellow passenger users are set to the same places as the places of departure and destinations of the fellow passenger users, places associated with living spheres and personal information of the fellow passenger users (e.g., home, work place, school, friend's house) are known to other users and so privacy may be lost. Therefore, getting-in spots and getting-off spots need to be set with the users' privacy taken into consideration in ride sharing. While the fellow passenger users do not want places associated with their own living spheres and personal information to be known, there is a possibility that the fellow passenger users may feel anxious about getting in or getting off the vehicle at a place where a third party cannot recognize a situation in which the fellow passenger users get in or get off the vehicle, such as a lonely place or a place without any security camera or the like.

In contrast, when setting getting-in spots, or getting-off spots of the fellow passenger users in the information processing apparatus according to the present disclosure, the controller acquires places of departure and destinations of the fellow passenger users first. Next, the controller determines spots which fall within a first range including the places of departure of the fellow passenger users, which are different from the places of departure and which a third party can recognize a situation in which the fellow passenger users get in the vehicle as the getting-in spots, and also determines spots which fall within a second range including the destinations of the fellow passenger users, which are different from the destinations and which a third party can recognize a situation in which the fellow passenger users get off the vehicle as the getting-off spots. The controller transmits the getting-in spots and the getting-off spots of the fellow passenger users to an apparatus related to the vehicle. This makes it possible to prevent the places of departure or the destinations of the fellow passenger users from being known to other users while securing safety of the fellow passenger users. As a result, it is possible to suitably prevent the fellow passenger users from losing privacy.

Note that the “apparatus related to the vehicle” referred to here is, for example, a terminal used by a driver user who is a user driving the vehicle or a vehicle-mounted terminal which is mounted on the vehicle and which specifies a traveling route of the vehicle. When the vehicle shared with the fellow passenger users is a vehicle manually driven by the driver user, the getting-in spots and getting-off spots set as described above are transmitted to the terminal used by the driver user or a vehicle-mounted apparatus such as a navigation apparatus, thus making it possible to cause the driver user to recognize the getting-in spots and getting-off spots of the fellow passenger users. When the vehicle shared with the fellow passenger users is an autonomously traveling vehicle, the getting-in spots and getting-off spots set as described above are transmitted to the vehicle-mounted apparatus such as a computer that controls autonomous traveling of the vehicle, and it is thereby possible to cause the vehicle to autonomously travel from the getting-in spots to the getting-off spots of the fellow passenger users.

The spot where a third party can recognize the situation in which the fellow passenger user gets in the vehicle or a situation in which the fellow passenger user gets off the vehicle is, for example, a place where the vehicle can be parked in commercial facilities in business (parking garage or carriage porch) or a place provided with a security camera where the vehicle can be parked. If such a place is set as the getting-in place or getting-off place, it is possible to reduce anxiety about the safety of the fellow passenger users.

Note that when the getting-in spots and the getting-off spots of the fellow passenger users are set at places excessively apart from the places of departure and destinations of the fellow passenger users, this may impair the convenience of the fellow passenger users. Thus, the above-described first range and second range may be set within a range in which the fellow passenger users can move on foot. In that case, it is possible to protect privacy the fellow passenger users without impairing the convenience of the fellow passenger users.

Hereinafter, specific embodiments of the present disclosure will be described based on the accompanying drawings. Dimensions, materials, shapes, and other relative arrangements or the like of components described in the present embodiments are not intended to limit the technical scope of the present disclosure to those embodiments unless specified otherwise.

### Embodiment

An example will be described in the present embodiment where the present disclosure is implemented in a mode in which a plurality of users intended for traveling share the same vehicle (hereinafter referred to as “ride-sharing”). Note that automobiles and trains or the like can be used as vehicles that can be shared among a plurality of users for a traveling purpose. A case will be described in the present embodiment where an automobile is used as an example of such vehicles.

(Overview of Ride-Sharing)

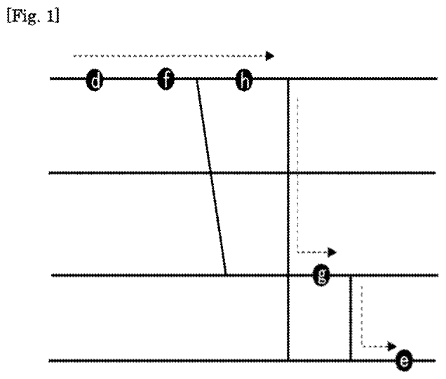

First an overview of ride-sharing will be described based on FIG. 1. In an example shown in FIG. 1, suppose that a user A travels from the place of departure d to the destination e, a user B travels from the place of departure f to the destination g and a user C travels from the place of departure h to the destination e.

Here, if the users A to C travel separately in their respective vehicles, three vehicles are necessary. In contrast, if the users A to C share the same vehicle, the users A to C can travel to their respective destinations in one vehicle. In the example shown in FIG. 1, the user A himself/herself drives a vehicle and travels from the point d to the point e. At this time, the user A allows the user B to get in the vehicle driven by the user A at the point f, and allows the user C to get in the vehicle driven by the user A at the point h. On the way to the point e which is the destination of the user A and the user C, the user A travels via the point g, where the user B gets off the vehicle, thus allowing the user B to travel from the place of departure f to the destination g. After that, the user A drives the vehicle from the point g to the point e to thereby allow the user C to travel from the place of departure h to the destination e, and at the same time the user A himself/herself can attain the traveling of the user A.

Such ride-sharing can reduce the number of vehicles traveling on a road, and can thereby relax traffic jam. Furthermore, since a plurality of users who share the same vehicle share transportation expenses (fuel expenses or the like) necessary for traveling in the vehicle, it is possible to cut down on a transportation cost per user compared to a case where each user travels in an individual vehicle.

Note that the aspect of ride-sharing shown in FIG. 1 is merely an example, and combinations of users who share one vehicle can be determined using well-known techniques.

In the example shown in FIG. 1, when the getting-in spots which are places where the users B and C (fellow passenger users) actually get in the vehicle driven by the user A (driver user) coincide with the places of departure f and h of the fellow passenger users or the getting-off spots which are places where the fellow passenger users actually get off the vehicle driven by the driver user coincide with the destinations (g, e) of the fellow passenger users, there is a possibility that living spheres of the fellow passenger users and places associated with personal information may be known to the other users. For example, when the places of departure f and h or the destinations g and e of the users B and C are homes and work places of the users B and C, if the places of departure f and h or destinations g and e are set as the getting-in spots and getting-off spots of the respective users, the homes and work places of the users B and C are known to the other users.

In contrast, according to the present embodiment, the getting-in spots and getting-off spots of the fellow passenger users are set to places different from places of departure and destinations of the fellow passenger users to thereby prevent the respective fellow passenger users from losing privacy. Furthermore, according to the present embodiment, the getting-in spots and getting-off spots of the fellow passenger users are set in consideration of the safety and convenience of the fellow passenger users. That is, places within a range (first range) in which the fellow passenger users can move on foot from the places of departure of the fellow passenger users and at which a third party can recognize the situation in which the fellow passenger users get in the vehicle are set as the getting-in spots, and places within a range (second range) in which the fellow passenger users can move on foot from the destinations of the fellow passenger users and at which a third party can recognize the situation in which the fellow passenger users get off the vehicle are set as the getting-off spots, and the safety and convenience of the fellow passenger users are thereby secured.

(System Configuration)

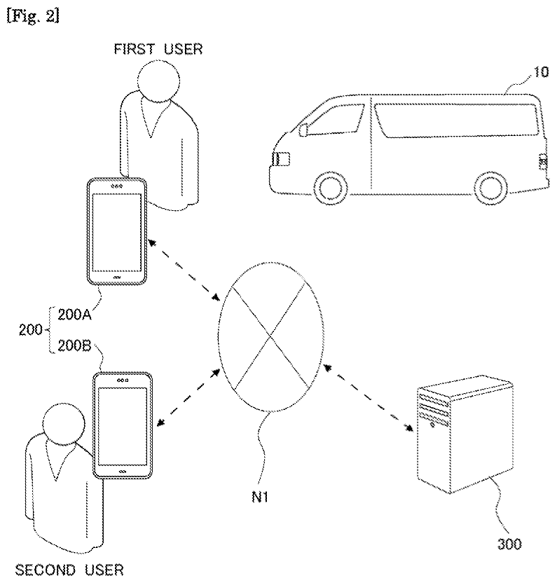

FIG. 2 is a diagram illustrating a configuration example of a system for providing a ride-sharing service (hereinafter may also be referred to as a “ride-sharing system”). In the example shown in FIG. 2, the ride-sharing system is constructed of a vehicle 10 used for ride sharing, a user terminal 200 used by a user sharing the vehicle 10 and a server apparatus 300. The user terminal 200 and the server apparatus 300 are mutually connectable via a network N1. A WAN (Wide Area Network) which is a worldwide public communication network such as the Internet or other communication networks may be adopted for the network N1. The network N1 may include a telephone communication network such as mobile phones or a wireless communication network such as WiFi.

Note that although only one vehicle 10 is illustrated in the example shown in FIG. 2 as the vehicle available for the ride-sharing service, suppose that the ride-sharing system includes a number of vehicles registered as vehicles available for the ride-sharing service. In the example shown in FIG. 2, only two terminals: a first user terminal 200A used by a driver user and a second user terminal 200B used by a fellow passenger user are illustrated, but suppose that the ride-sharing system includes a number of user terminals corresponding to the number of users registered as members entitled to use the ride-sharing service.

A predetermined application for using a ride-sharing service is installed in the user terminal 200. The user of the user terminal 200 causes the own user terminal 200 to execute the above predetermined application, and can thereby register information relating to conditions or the like when sharing a vehicle (hereinafter may also be referred to as “request information”) in the server apparatus 300. For example, the driver user causes the first user terminal 200A to execute the above-described predetermined application, and can thereby register information relating to the own scheduled traveling section of the vehicle 10 and the traveling date and time or the like (traveling schedule) in the server apparatus 300 as request information. The fellow passenger user causes the second user terminal 200B to execute the above-described predetermined application, and can thereby register information relating to the own desired movement section and movement date and time or the like (movement schedule) in the server apparatus 300 as request information. Note that details of the user terminal 200 will be described later.

The server apparatus 300 receives the request information from the driver user and the request information from the fellow passenger user. The server apparatus 300 determines a provisional combination of a driver user and a fellow passenger user based on the request information from the driver user and the request information from the fellow passenger user. The server apparatus 300 transmits information indicating ride sharing conditions to the user terminals 200 of the driver user and the fellow passenger user in the above provisional combination. When the server apparatus 300 receives information accepting the ride sharing conditions from the respective user terminals 200 of the driver user and the fellow passenger user, the server apparatus 300 confirms the above provisional combination as an official combination. Hereinafter, a process for the server apparatus 300 to confirm a combination of a driver user and a fellow passenger user using the above procedure will be referred to as a “matching process.”

The server apparatus 300 according to the present embodiment is provided with a function of setting getting-in spots and getting-off spots of the fellow passenger users based on the places of departure and destinations of the fellow passenger users in addition to the function of the above-described matching processing. The server apparatus 300 provided with these functions corresponds to the “information processing apparatus” according to the present disclosure.

(Hardware Configuration)

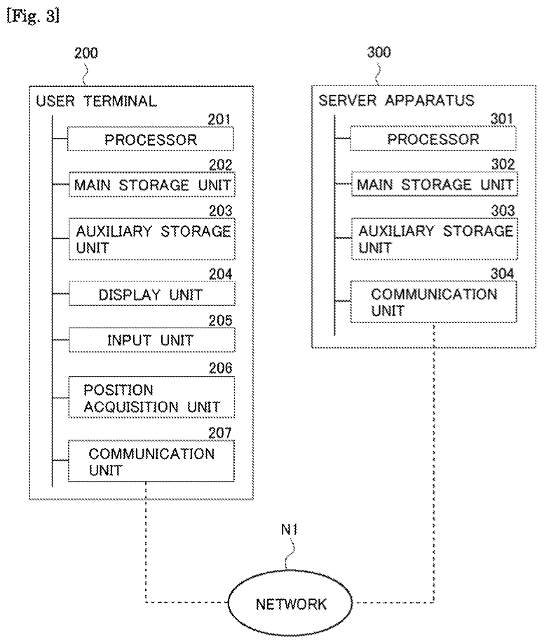

FIG. 3 is a diagram illustrating a hardware configuration of each of the user terminal 200 and the server apparatus 300. Note that the first user terminal 200A and the second user terminal 200B shown in aforementioned FIG. 2 each have a hardware configuration similar to the configuration of the user terminal 200 in FIG. 3.

The server apparatus 300 has a configuration of a general computer. That is, the server apparatus 300 includes a processor 301, a main storage unit 302, an auxiliary storage unit 303 and a communication unit 304. These components are mutually connected via a bus. The main storage unit 302 and the auxiliary storage unit 303 are computer-readable storage media. The hardware configuration of the computer is not limited to the configuration example shown in FIG. 3, but components may be omitted, replaced or added as appropriate.

The server apparatus 300 implements functions matching to a predetermined object by the processor 301 loading a work region of the main storage unit 302 with a program stored in the storage medium and executing the program, and controlling the respective function components through execution of the program.

The processor 301 is, for example, a CPU (Central Processing Unit) or a DSP (Digital Signal Processor). The processor 301 controls the server apparatus 300 and performs operations of various kinds of information processing. The main storage unit 302 includes, for example, a RAM (Random Access Memory) and a ROM (Read Only Memory). The auxiliary storage unit 303 is, for example, an EPROM (Erasable Programmable ROM) or a hard disk drive (HDD). Furthermore, the auxiliary storage unit 303 can include a removable medium, that is, a removable storage medium. The removable medium is a disk storage medium such as a USB (Universal Serial Bus) memory, a CD (Compact Disc) or a DVD (Digital Versatile Disc).

The auxiliary storage unit 303 stores various programs, various kinds of data and various tables in a storage medium in a freely readable/writable state. The auxiliary storage unit 303 stores an operating system (OS), various programs and various tables or the like. Note that a part or a whole of these pieces of information may also be stored in the main storage unit 302. Information stored in the main storage unit 302 may be stored in the auxiliary storage unit 303.

The communication unit 304 transmits/receives information between an external apparatus and the server apparatus 300. The communication unit 304 is, for example, a LAN (Local Area Network) interface board or a wireless communication circuit for wireless communication. The LAN interface board or wireless communication circuit is connected to a network N1.

A series of processes executed by the server apparatus 300 configured as described above may be executed by hardware or may also executed by software.

Next, the user terminal 200 is a small computer that can be carried by the user such as a smartphone, a mobile phone, a tablet terminal, a personal information terminal, a wearable computer (smart watch or the like). Note that the user terminal 200 may also be a personal computer (PC) connected to the server apparatus 300 via the network N1 such as the Internet which is a public communication network.

The user terminal 200 includes a processor 201, a main storage unit 202, an auxiliary storage unit 203, a display unit 204, an input unit 205, a position acquisition unit 206 and a communication unit 207. Since the processor 201, the main storage unit 202 and the auxiliary storage unit 203 are similar to the processor 301, the main storage unit 302 and the auxiliary storage unit 303 of the server apparatus 300, description thereof is omitted. The display unit 204 is, for example, an LCD (Liquid Crystal Display) or an EL (Electroluminescence) panel. The input unit 205 includes, for example, a touch panel that allows symbols such as characters to be inputted, push buttons, a microphone that allows voice to be inputted or a camera that allows a moving image or still image to be picked up. The position acquisition unit 206 is a device that acquires a current position of the user terminal 200 and is typically configured by including a GPS receiver or the like. The communication unit 207 is a communication circuit for accessing the network N1 using, for example, a mobile communication service (telephone communication network such as a mobile phone or wireless communication of WiFi or the like) and carrying out data communication with the server apparatus 300 or the like.

(Functional Configuration of Server Apparatus)

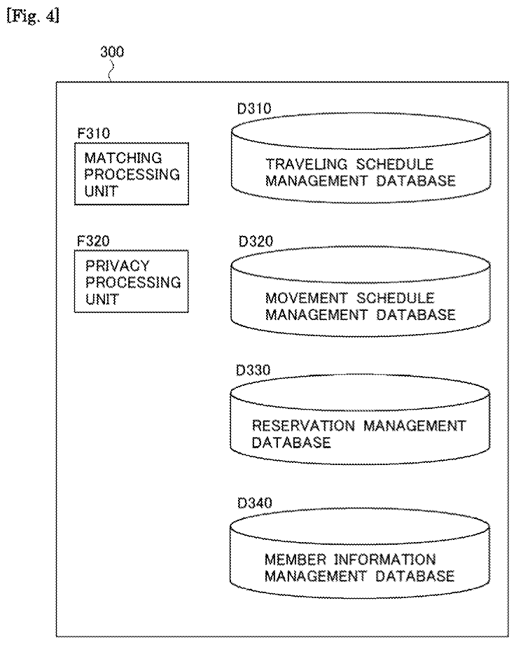

Here, a functional configuration of the server apparatus 300 will be described based on FIG. 4. As shown in FIG. 4, the server apparatus 300 of the present embodiment includes, as functional components thereof, a matching processing unit F310, a privacy processing unit F320, a traveling schedule management database D310, a movement schedule management database D320 and a reservation management database D330. Here, the matching processing unit F310 and the privacy processing unit F320 are formed by the processor 301 of the server apparatus 300 executing a computer program in the main storage unit 302. Note that any one or part of the matching processing unit F310 and the privacy processing unit F320 may be formed of a hardware circuit.

The traveling schedule management database D310, the movement schedule management database D320, the reservation management database D330 and a member information management database D340 are constructed by a program of a database management system (DBMS) executed by the processor 301 of the server apparatus 300 managing data stored in the auxiliary storage unit 303. These traveling schedule management database D310, movement schedule management database D320, reservation management database D330 and member information management database D340 are, for example, relational databases.

Note that any one or part of processing thereof of the respective functional components of the server apparatus 300 may be executed by another computer connected to the network N1. For example, each process included in the matching processing unit F310 and each process included in the privacy processing unit F320 may be executed by different computers.

The traveling schedule management database D310 stores a traveling schedule of each vehicle 10, where identification information of a driver user of the vehicle 10 is associated with a traveling schedule of the vehicle 10. Here, a configuration example of traveling schedule information stored in the traveling schedule management database D310 will be described based on FIG. 5. FIG. 5 is a diagram illustrating a table configuration of traveling schedule information. Note that information registered in the traveling schedule information table is not limited to the example shown in FIG. 5, but fields may be added, changed or deleted as appropriate.

The traveling schedule information table shown in FIG. 5 includes fields such as a vehicle ID, a driver user ID, a place of departure, a scheduled date and time of departure, a destination, a scheduled date and time of arrival, and a status. A vehicle ID which is information for identifying each vehicle 10 available for ride sharing is registered in the vehicle ID field. The vehicle ID referred to here is information assigned together with a user ID which will be described later when a driver user of each vehicle 10 applies for membership registration for a ride-sharing service, and is information for identifying each vehicle 10. A certain user ID which is information for identifying a driver user of each vehicle 10 available for ride sharing is registered in the driver user ID field. The user ID is information assigned when a driver user of the vehicle 10 available for ride sharing applies for membership registration for a ride-sharing service. Information indicating a place of departure of the vehicle 10 available to each driver user for ride sharing is registered in the place of departure field. Note that the place of departure referred to here is not limited to a place where the driver user starts traveling in the vehicle 10, but can be changed by the driver user according to his/her convenience as appropriate. Information indicating a scheduled date and time of departure at which the driver user leaves the above place of departure in the vehicle 10 driven by the driver user is registered in the scheduled date and time of departure field. Information indicating a destination for which the driver user is heading in the vehicle 10 available for ride sharing is registered in the destination field. Note that the destination referred to here is not limited to a place where the driver user's traveling in the vehicle 10 ends, but can be changed according to the convenience of the driver user as appropriate. Information indicating a scheduled date and time at which the driver user traveling in the vehicle 10 driven by the driver user arrives at the above destination is registered in the scheduled date and time of arrival field. Information indicating a traveling situation of the vehicle 10 driven by the driver user is registered in the status field. For example, the status is registered as “already arrived” when the vehicle 10 driven by the driver user has already arrived at the destination, and the status is registered as “traveling” when the vehicle 10 driven by the driver user is traveling from the place of departure to the destination, and the status is registered as “before departure” when the vehicle 10 driven by the driver user has not departed from the place of departure yet. Note that for the vehicle 10 registered as “traveling” in the above status field, information relating to the current position of the vehicle 10 may also be registered in the status field. A current position of the vehicle 10 in that case may be acquired by the server apparatus 300 through communication with the user terminal 200 of the driver user or may be acquired by the server apparatus 300 through communication with a device mounted on the vehicle 10 enabled to communicate.

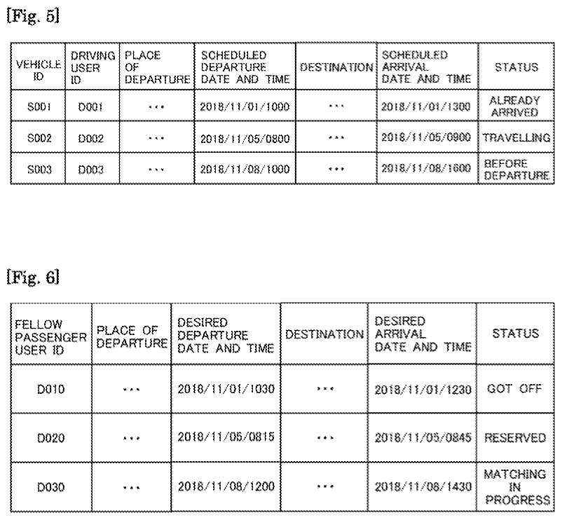

The movement schedule management database D320 stores a movement schedule of a fellow passenger user who wants ride sharing of an arbitrary vehicle 10, where identification information of the fellow passenger user is associated with the movement schedule. Here, one configuration example of the movement schedule information stored in the movement schedule management database D320 will be described based on FIG. 6. FIG. 6 is a diagram illustrating a table configuration of the movement schedule information. Note that the information registered in the movement schedule information table is not limited to the example shown in FIG. 6, but fields can be added, changed or deleted as appropriate.

The movement schedule information table shown in FIG. 6 includes fields such as a fellow passenger user ID, a place of departure, a desired departure date and time, a destination, a desired arrival date and time and a status. A user ID for identifying each fellow passenger user is registered in the fellow passenger user ID field. The user ID of the fellow passenger user is information assigned when the fellow passenger user applies for membership registration for a ride-sharing service as in the case of the aforementioned driver user ID. Information indicating a spot (place of departure) where each fellow passenger user starts movement is registered in the place of departure field. Information indicating a date and time at which each fellow passenger user wants to start movement from the above-described place of departure is registered in the desired departure date and time field. Information indicating a spot (destination) at which each fellow passenger user ends the movement is registered in the destination field. Information indicating a date and time at which each fellow passenger user wants to arrive at the above-described destination is registered in the desired arrival date and time field. Information indicating a traveling situation of the fellow passenger user is registered in the status field. For example, the status is registered as “already got off” when the fellow passenger user has already gotten off the vehicle 10 available for ride sharing, the status is registered as “reserved” when a driver user to be combined with a fellow passenger user is confirmed but the fellow passenger user has not yet got on the vehicle 10 driven by the driver user, and the status is registered as “matching in progress” when a driver user to be combined with a fellow passenger user is not confirmed yet.

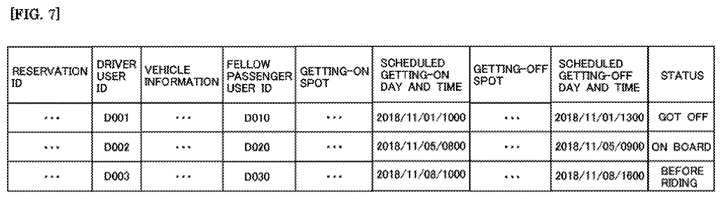

The reservation management database D330 stores reservation information for a ride-sharing service, where information relating to the driver user is associated with information relating to a fellow passenger user scheduled to share the vehicle 10 driven by the driver user. Here, one configuration example of reservation information stored in the reservation management database D330 will be described based on FIG. 7. FIG. 7 is a diagram illustrating a table configuration of reservation information. Note that information registered in the reservation information table is not limited to the example shown in FIG. 7, but fields can be added, changed or deleted as appropriate.

The reservation information table shown in FIG. 7 includes fields such as a reservation ID, a driver user ID, a vehicle information, a fellow passenger user ID, a getting-on spot, a scheduled getting-on date and time, a getting-off spot, a scheduled getting-off date and time and a status. A reservation ID which is information for identifying individual reservation information is registered in the reservation ID field. For example, this reservation ID is used when each user confirms or changes reservation contents. A user ID of a driver user driving the vehicle 10 that can be shared is registered in the driver user ID field. Information necessary for a fellow passenger user who shares the vehicle 10 to identify the vehicle 10 driven by each driver user is registered in the vehicle information field. For example, information such as vehicle model, automobile registration number (number displayed on the number plate), vehicle body color or the like is registered in the vehicle information field. A user ID of a fellow passenger user scheduled to share the vehicle 10 driven by each driver user is registered in the fellow passenger user ID field. Information indicating a place where a fellow passenger user is allowed to get on the vehicle 10 driven by each driver user (getting-on spot) is registered in the getting-on spot field. Information indicating a scheduled date and time at which a fellow passenger user is allowed to get on the vehicle 10 driven by each driver user at the above getting-on spot is registered in the scheduled getting-on date and time field. Information indicating a place where a fellow passenger user is allowed to get off the vehicle 10 driven by each driver user (getting-off spot) is registered in the getting-off spot field. Information indicating a scheduled date and time at which a fellow passenger user is allowed to get off the vehicle 10 driven by each driver user at the above getting-off spot is registered in the scheduled getting-off date and time field. Information indicating a ride sharing situation of each vehicle 10 is registered in the status field. For example, the status is registered as “already got off” when the fellow passenger user has already got off the vehicle 10 at the above getting-off spot, the status is registered as “getting on” when the fellow passenger user is sharing the vehicle 10 and the status is registered as “before getting on” in a stage before the fellow passenger user gets on the vehicle 10. Note that it is assumed in this example that the above-described getting-in spot and getting-off spot are set to places different from the places of departure and destinations of the fellow passenger users. The method of setting those getting-in spots and getting-off spots will be described later.

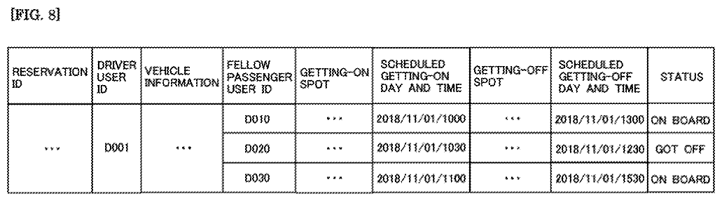

The reservation information table in FIG. 7 corresponds to a table configuration example when one fellow passenger user shares the vehicle 10 driven by each driver user, but the number of fellow passenger users who share the vehicle 10 driven by each driver user may be two or more. In that case, as shown in FIG. 8, one driver user ID may be associated with information of a plurality of fellow passenger users.

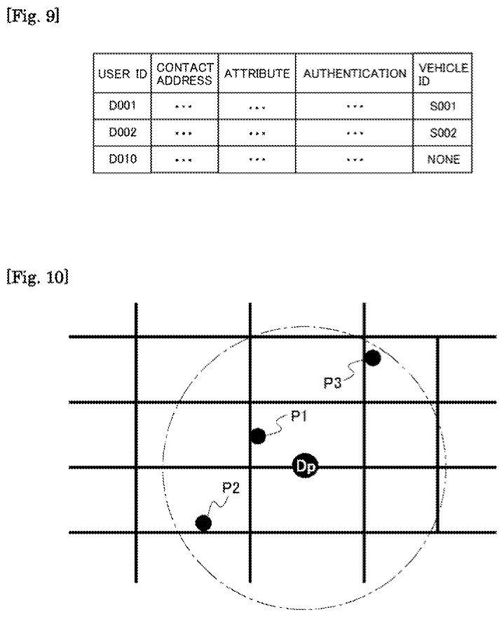

The member information management database D340 stores information on users registered as members in the ride-sharing service (member information). Here, one configuration example of member information stored in the member information management database D340 will be described based on FIG. 9. FIG. 9 is a diagram illustrating a table configuration of member information. Note that information registered in the member information table is not limited to the example shown in FIG. 9, but fields can be added, changed or deleted as appropriate.

The member information table shown in FIG. 9 includes fields such as a user ID, a contact address, an attribute, authentication and a vehicle ID. A user ID assigned when each user applies for member registration for a ride-sharing service is registered in the user ID field. Information indicating a contact address of each user (e.g., electronic mail address, telephone number, or the like, including at least an electronic mail address of the user terminal 200 used by each user) is registered in the contact field. Information indicating an attribute of each user (e.g., name, nickname, age, gender, occupation, work place (school), hobby, skill or the like) is registered in the attribute field. Information indicating a password or the like necessary for authentication when the aforementioned request information is registered in the server apparatus 300 or when the aforementioned reservation information is confirmed is registered in the authentication field. A vehicle ID of the vehicle 10 available to each user for ride sharing is registered in the vehicle ID field. Note that, for example. “None” is registered in the vehicle ID field for a user not possessing the vehicle 10 available for ride sharing.

Next, the matching processing unit F310 performs a matching process based on request information from a driver user or a fellow passenger user. More specifically, when the server apparatus 300 receives request information transmitted from the user terminal 200 of the driver user, the matching processing unit F310 generates a traveling schedule information table as shown in aforementioned FIG. 5 based on the request information and stores the generated traveling schedule information table in the traveling schedule management database D310. Furthermore, when the server apparatus 300 receives request information transmitted from the user terminal 200 of the fellow passenger user, the matching processing unit F310 generates a movement schedule information table as shown in aforementioned FIG. 6 based on the request information and stores the generated movement schedule information table in the movement schedule management database D320. The matching processing unit F310 compares the traveling schedule information table stored in the traveling schedule management database D310 and the movement schedule information table stored in the movement schedule management database D320 and extracts a traveling schedule suitable for a movement schedule of each fellow passenger user. Next, the matching processing unit F310 provisionally combines the driver user associated with the extracted traveling schedule and the above fellow passenger user. When a provisional combination of the driver user and the fellow passenger users is determined in the above-described procedure, a privacy processing unit F320, which will be described later, performs a process (privacy process) of setting the getting-in spots and getting-off spots of the fellow passenger users. After that, the matching processing unit F310 transmits information indicating ride sharing conditions including the getting-in spots and getting-off spots set in the above-described privacy process (e.g., getting-in spots of the fellow passenger users, scheduled getting-in date and time of the fellow passenger users, getting-off spots of the fellow passenger users, scheduled getting-off date and time of the fellow passenger users and type of the vehicle 10 or the like) to the respective user terminals 200 of the driver user and the fellow passenger users in the above-described provisional combination. In response to this, when information accepting the above ride sharing conditions are sent back from both user terminals 200 of the driver user and the fellow passenger user, the matching processing unit F310 confirms the above provisions combination as an official combination. Accordingly, the matching processing unit F310 generates a reservation information table as shown in aforementioned FIGS. 7 and 8 based on the above official combination, and stores the generated reservation information table in the reservation management database D330. Note that the method for executing the matching process by the matching processing unit F310 is not limited to the above method, but the matching process may be executed using other methods using known techniques.

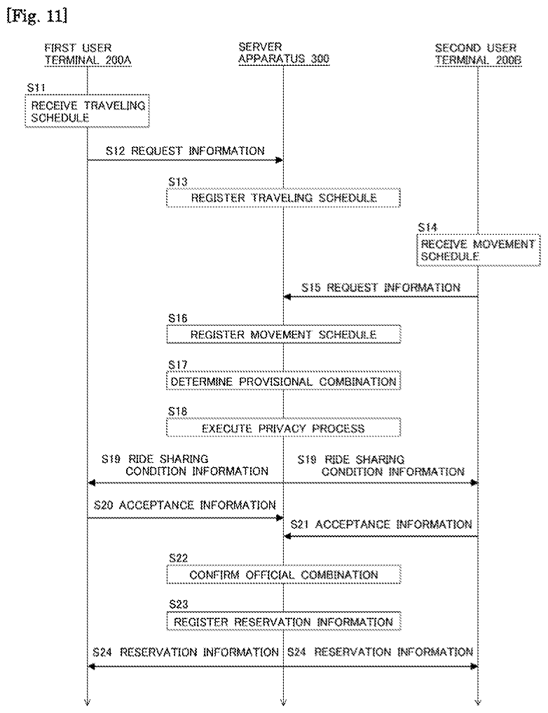

As described above, when the provisional combination of the driver user and fellow passenger users is determined, the privacy processing unit F320 performs a privacy process to set the getting-in spots and getting-off spots of the fellow passenger users. The privacy process in this example is a process of setting the getting-in spots of the fellow passenger users to places different from the places of departure of the fellow passenger users and setting the getting-off spots of the fellow passenger users to places different from the destinations of the fellow passenger users. Here, a method of setting the getting-in spots and getting-off spots of the fellow passenger users will be described. Note that since the getting-off spots are set using a method similar to that of setting the getting-in spots, the method of setting the getting-in spots will be described here based on FIG. 10. FIG. 10 is a diagram illustrating a road map around a place of departure of a fellow passenger user (“Dp” in FIG. 10).

The privacy processing unit F320 extracts places which fall within a range (range enclosed by a single-dot dashed line in FIG. 10) in which the fellow passenger user can move on foot from the place of departure Dp and at which a third party can recognize the situation in which the fellow passenger user gets in the vehicle 10 used for ride sharing (hereinafter may also be referred to as a “visually recognizable spot”). As the visually recognizable spot referred to here, for example, a place where the vehicle can be parked (parking garage, carriage porch or the like) at commercial facilities (store, lodging facilities, amusement facilities or the like) in business on a scheduled departure date and time of the fellow passenger user or a place where the vehicle can be parked provided with a security camera are extracted. Note that information relating to locations and business hours of commercial facilities located within the ride sharing service providing area and information relating to the installation locations of security cameras may be collected and made into database in advance.

Once a visually recognizable spot located within a range in which the fellow passenger user can move on foot from the place of departure Dp is extracted, the privacy processing unit F320 sets the extracted visually recognizable spot as the getting-in spot. Note that as the example shown in FIG. 10, when there are a plurality of visually recognizable spots (P1, P2 and P3 in FIG. 10) located within a range in which the fellow passenger user can move on foot from the place of departure Dp, the privacy processing unit F320 may set a visually recognizable spot closest to the place of departure Dp (P1 in FIG. 10) in consideration of the fellow passenger user's convenience as the getting-in spot. Note that from the standpoint of protection of privacy of the fellow passenger user, a visually recognizable spot farthest from the place of departure Dp (P3 in FIG. 10) may be set as the getting-in spot or a visually recognizable spot including at least two turning points located between the spot and the place of departure Dp (P2 in FIG. 10) may be set as the getting-in spot. Furthermore, when commercial facilities and a security camera installation place are located within the range in which the fellow passenger user can move on foot from the place of departure Dp, the commercial facilities may be set as the getting-in spot more preferentially than the security camera installation place. The method of selecting a visually recognizable spot suitable for the getting-in spot from among a plurality of visually recognizable spots is not limited to the above-described method, but can be changed according to the situation as appropriate.

When the getting-in spots and getting-off spots are set to places different from the places of departure and destinations using the above-described method, it is possible to prevent the places of departure and destinations of the fellow passenger users from being known to other users while securing the safety of the fellow passenger users. As a result, even when the places of departure and destinations of the fellow passenger users are places associated with the living spheres and personal information of the fellow passenger users, it is possible to suitably prevent such places from being known to other users.

(System Operation)

An operation flow of the ride sharing system according to the present embodiment will be described. FIG. 11 is a diagram illustrating the operation flow of the ride sharing system according to the present embodiment. FIG. 11 is a flowchart illustrating an overview of a flow of data transmitted/received among the respective components in ride sharing and a processing flow carried out in each component.

In FIG. 11, when the first user terminal 200A receives input of a traveling schedule to the input unit 205 by the driver user (S11), the first user terminal 200A transmits the traveling schedule from the communication unit 207 to the server apparatus 300 as request information (S12).

When the communication unit 304 of the server apparatus 300 receives the request information from the first user terminal 200A, the matching processing unit F310 generates a traveling schedule information table as shown in aforementioned FIG. 5 based on the request information and registers the generated traveling schedule information table in the traveling schedule management database D310 (S13).

Upon receiving the input of the movement schedule to the input unit 205 by the fellow passenger user (S14), the second user terminal 200B transmits the movement schedule from the communication unit 207 to the server apparatus 300 as request information (S15).

When the communication unit 304 of the server apparatus 300 receives the request information from the second user terminal 200B, the matching processing unit F310 generates a movement schedule information table as shown in aforementioned FIG. 6 based on the request information and registers the generated movement schedule information table in the movement schedule management database D320 (S16).

Note that the method for each user to have the above request information registered in the server apparatus 300 is not limited to the method using the user terminals 200A, 200B. For example, the above request information may also be registered in the server apparatus 300 using an arbitrary terminal connectable to the network N1 (smartphone, mobile phone, tablet terminal, personal information terminal, wearable computer or the like) or a personal computer (PC). Furthermore, in the example shown in FIG. 11, the request information from the first user terminal 200A is transmitted to the server apparatus 300 earlier than the request information from the second user terminal 200B, but the request information from the second user terminal 200B may also be transmitted to the server apparatus 300 earlier than the request information from the first user terminal 200A.

The matching processing unit F310 of the server apparatus 300 compares the traveling schedule information table stored in the traveling schedule management database D310 with the movement schedule information table stored in the movement schedule management database D320 and extracts a traveling schedule that matches the movement schedule of each fellow passenger user. Next, the matching processing unit F310 provisionally combines the driver user associated with the extracted traveling schedule with the fellow passenger user (S17).

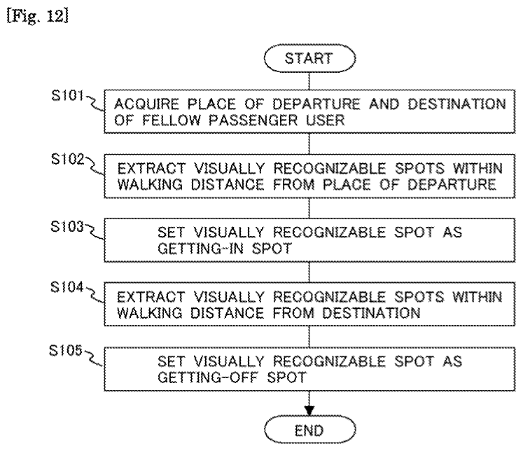

When the provisional combination between the driver user and the fellow passenger user is determined, the privacy processing unit F320 of the server apparatus 300 executes a privacy process (S18). The privacy process is executed based on a processing flow as shown in FIG. 12.

In FIG. 12, the privacy processing unit F320 accesses the movement schedule information table corresponding to the fellow passenger user included in the provisional combination, and thereby acquires the place of departure and the destination of the fellow passenger user (S101). Next, the privacy processing unit F320 extracts visually recognizable spots located within a range in which the fellow passenger user can move on foot from the place of departure (within a walking distance) using the method described in aforementioned FIG. 10 (S102) and sets the extracted visually recognizable spots as the getting-in spots (S103). In that case, if a plurality of visually recognizable spots are located within the walking distance, one visually recognizable spot may be selected based on the standpoint of the convenience or privacy protection of the fellow passenger user and the selected visually recognizable spot may be set as the getting-in spot. The privacy processing unit F320 also extracts visually recognizable spots located within a range in which the fellow passenger user can move on foot from the destination (within a walking distance) (S104) and sets the extracted visually recognizable spot as the getting-off spot (S105). Note that the method of extracting the visually recognizable spot as the getting-off spot target is similar to the method described in aforementioned FIG. 10.

Here returning to FIG. 11, the matching processing unit F310 of the server apparatus 300 transmits information indicating the ride sharing condition including the getting-in spots and getting-off spots set in the privacy process in S18 (getting-in spots of the fellow passenger users, scheduled getting-in date and time of the fellow passenger users, getting-off spots of the fellow passenger users, scheduled getting-off date and time of the fellow passenger users, type of the vehicle 10 or the like) from the communication unit 304 to the first user terminal 200A and the second user terminal 200B (S19).

When the first user terminal 200A and the second user terminal 200B receive information indicating the ride sharing condition, the respective user terminals 200A and 200B display information indicating the ride sharing condition in the above-described provisional combination on the display unit 204. In that case, the respective user terminals 200A and 200B perform a process of urging each user to select whether or not to accept the information indicating the ride sharing condition (e.g., a process of causing the input unit 205 to display a button to select whether or not to accept the ride sharing condition on a touch panel or the like). When each user selects to accept the information indicating the ride sharing condition, each user terminal 200A or 200B transmits information indicating acceptance of the ride sharing condition in the above-described provisional combination (acceptance information) from the communication unit 207 to the server apparatus 300 (S20, S21). Note that in the example shown in FIG. 11, the acceptance information from the first user terminal 200A is transmitted to the server apparatus 300 earlier than the acceptance information from the second user terminal 200B, but the acceptance information from the second user terminal 200B can be transmitted earlier than the acceptance information from the first user terminal 200A.

When the communication unit 304 of the server apparatus 300 receives the acceptance information which is information indicating acceptance of the ride sharing condition in the above-described provisional combination, the matching processing unit F310 confirms the above-described provisional combination as an official combination (S22). The matching processing unit F310 generates the reservation information tables as shown in aforementioned FIGS. 7 and 8 based on the ride sharing condition in the official combination and registers the generated reservation information table in the reservation management database D330 (S23). The matching processing unit F310 transmits the information (reservation information) included in the generated reservation information table to the first user terminal 200A and the second user terminal 200B (S24).

Note that when neither the first user terminal 200A nor the second user terminal 200B can receive the above-described acceptance information, the matching processing unit F310 of the server apparatus 300 is assumed to reset a new provisional combination made up of a user combination different from the above-described provisional combination.

According to the aforementioned flow, the getting-in spots and getting-off spots of the fellow passenger users are set to places different from the places of departure and the destinations of the fellow passenger users, and so even when the places of departure and the destinations are places associated with the living spheres and personal information of the fellow passenger users, it is possible to prevent those places from being known to other users. Furthermore, since the getting-in spots and getting-off spots of the fellow passenger users are set to visually recognizable spots at which a third party can recognize the situation in which the fellow passenger users get in the vehicle 10, it is also possible to secure the safety of the fellow passenger users. It is thereby possible to suitably prevent the fellow passenger users from losing privacy

### Modifications

A mode has been illustrated in the aforementioned embodiment where a vehicle manually driven by the driver user is used for ride sharing, but an autonomous traveling vehicle may be used for ride sharing. In that case, of the reservation information generated through the matching process, information necessary for the operation of the vehicle (e.g., getting-in spots, scheduled getting-in date and time, getting-off spots and scheduled getting-off date and time) may be transmitted to a computer mounted on the autonomous traveling vehicle instead of the first user terminal 200A. Accordingly, in a mode in which an autonomous traveling vehicle is used for ride sharing, it is possible to prevent the place of departure or the destination of each fellow passenger user from being known to other fellow passenger users while securing the safety of each fellow passenger user.

Although an example has been described in the aforementioned embodiment where the getting-in spots and getting-off spots of the fellow passenger users are determined by the server apparatus 300, a fellow passenger user who confirms the determined getting-in spot and getting-off spot may be enabled to request that the getting-in spot and the getting-off spot be changed. In that case, the server apparatus 300 may change only the getting-in spot and getting-off spot without changing the combination between the driver user and the fellow passenger users.

### Others

Note that the above embodiments are merely examples and the present disclosure can be changed and implemented as appropriate without departing from the spirit and scope of range of the present disclosure.

The processes and means described in the present disclosure may be freely combined and implemented unless there are technical inconsistencies. A process described as being performed by one device may be shared and executed among a plurality of devices. Alternatively, processes described as being executed by different devices may be executed by one device. In a computer system, it is possible to flexibly change a hardware configuration used to implement each function.

Furthermore, the present disclosure can also be implemented by supplying a computer program (information processing program) including the functions described in the above embodiments to a computer and by one or more processors included in the computer reading and executing the program. Such a computer program may be supplied to the computer through a non-transitory computer readable storage medium which is connectable to a system bus of the computer or may be supplied to the computer via a network. The non-transitory computer readable storage medium is a storage medium (non-transitory storage medium) which allows information such as data or a program to be stored through electrical, magnetic, optical, mechanical or chemical action and read from the computer or the like, and examples of such a medium include any type of disk such as magnetic disk (floppy (registered trademark) disk, hard disk drive (HDD) or the like), optical disk (CD-ROM, DVD disk, blue-ray disk or the like), read-only memory (ROM), random access memory (RAM), EPROM, EEPROM, magnetic card, flash memory, optical card and SSD (Solid State Drive).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus in a mode in which a plurality of users share a same vehicle, that sets getting-in spots and getting-off spots of fellow passenger users who ride in the vehicle as non-drivers, the information processing apparatus comprising a controller including at least one processor,
the controller configured to execute;
acquiring places of departure and destinations of the fellow passenger users;
determining as getting-in spots, spots which are different from the places of departure in a first range including the places of departure of the fellow passenger users and at which a third party can recognize a situation in which the fellow passenger users get in the vehicle;
determining as getting-off spots, spots which are different from the destinations in a second range including the destinations of the fellow passenger users and at which a third party can recognize a situation in which the fellow passenger users get off the vehicle; and
transmitting the getting-in spots and the getting-off spots of the fellow passenger users to an apparatus related to the vehicle.

2. The information processing apparatus according to claim 1, wherein the apparatus related to the vehicle is a terminal used by a driver user who is a user who drives the vehicle or a vehicle-mounted terminal that is mounted on the vehicle to specify a traveling route of the vehicle.

3. The information processing apparatus according to claim 1, wherein the spot where the third party can recognize the situation in which the fellow passenger users get in the vehicle or the situation in which the fellow passenger users get off the vehicle is a place where the vehicle can he parked at commercial facilities in business.

4. The information processing apparatus according to claim 2, wherein the spot where the third party can recognize the situation in which the fellow passenger users get in the vehicle or the situation in which the fellow passenger users get off the vehicle is a place where the vehicle can be parked at commercial facilities in business.

5. The information processing apparatus according to claim 1, wherein the spot where the third party can recognize the situation in which the fellow passenger users get in the vehicle or the situation in which the fellow passenger users get off the vehicle is a place where the vehicle can be parked where a security camera is installed.

6. The information processing apparatus according to claim 2, wherein the spot where the third party can recognize the situation in which the fellow passenger users get in the vehicle or the situation in which the fellow passenger users get off the vehicle is a place where the vehicle can be parked where a security camera is installed.

7. The information processing apparatus according to claim 1, wherein
the first range is a range in which the fellow passenger user can move on foot from the place of departure, and
the second range is a range in which the fellow passenger user can move on foot from the destination.

8. An information processing method in a mode in which a plurality of users share a same vehicle, of setting getting-in spots and getting-off spots of fellow passenger users who ride in the vehicle as non-drivers, the information processing method being configured to cause a computer to execute:
a step of acquiring places of departure and destinations of the fellow passenger users;
a step of determining as getting-in spots, spots which are different from the places of departure in a first range including the places of departure of the fellow passenger users and at which a third party can recognize a situation in which the fellow passenger users get in the vehicle;
a step of determining as getting-off spots, spots which are different from the destinations in a second range including the destinations of the fellow passenger users and at which a third party can recognize a situation in which the fellow passenger users get off the vehicle; and
a step of transmitting the getting-in spots and the getting-off spots of the fellow passenger users to an apparatus related to the vehicle.

9. A non-transitory storage medium that stores an information processing program in a mode in which a plurality of users share a same vehicle, for setting getting-in spots and getting-off spots of fellow passenger users who ride in the vehicle as non-drivers, the information processing program causing a computer to execute:
a step of acquiring places of departure and destinations of the fellow passenger users;
a step of determining as getting-in spots, spots which are different from the places of departure in a first range including the places of departure of the fellow passenger users and at which a third party can recognize a situation in which the fellow passenger users get in the vehicle;
a step of determining as getting-off spots, spots which are different from the destinations in a second range including the destinations of the fellow passenger users and at which a third party can recognize a situation in which the fellow passenger users get off the vehicle; and
a step of transmitting the getting-in spots and the getting-off spots of the fellow passenger users to an apparatus related to the vehicle.
